(19) United States
(12) Patent Application Publication
(10) Pub. No.: US 2017/0026808 A1
(43) Pub. Date: Jan. 26, 2017

(54) SYSTEM AND METHOD FOR DIGITAL COMMUNICATION OVER EXISTING WIRING

(71) Applicant: 5-D Systems, Inc., Round Rock, TX (US)

(72) Inventors: Darren Scott Johnson, Austin, TX (US); Bennie Ray Kirk, Austin, TX (US)

(73) Assignee: 5-D Systems, Inc., Round Rock, TX (US)

(21) Appl. No.: 15/069,599

(22) Filed: Mar. 14, 2016

Related U.S. Application Data
(60) Provisional application No. 62/132,620, filed on Mar. 13, 2015.

(51) Int. Cl. H04W 4/04; H04Q 1/02

(52) U.S. Cl. CPC H04W 4/046; H04Q 1/11

(57) ABSTRACT

Disclosed are systems and methods for transmitting high speed digital network data over existing wiring in legacy platforms. In some embodiments, high-speed digital data can be communicated over existing wiring and infrastructure on air, land, and marine platforms. The disclosed systems and methods are beneficial for platforms that were designed, developed, and manufactured before modern high speed communications were standardized, so they typically lack the communications infrastructure required to integrate advanced systems at remote points within the platform. The disclosed communications technology enables a legacy platform or infrastructure to take advantage of the advancements in sensor and payload technology since the production of such platform.

### CROSS-REFERENCE TO RELATED PATENT APPLICATION

This application claims priority to U.S. Patent Application Ser. No. 62/132,620, entitled “System And Method For Digital Communication Over Existing Wiring,” filed on Mar. 13, 2015. This application is commonly assigned to the Assignee of the present invention and is hereby incorporated herein by reference in its entirety for all purposes.

### GOVERNMENT INTEREST

This work was supported by the Air Force Research Lab (AFRL) under a Phase II Small Business Innovation Research (SBIR) contract, number FA8750-11-C-0217. Further development was funded by the Defense Advanced Research Projects Agency (DARPA) through an existing contract with Raytheon Missile Systems (contract number FA8650-11-C-7116) wherein the inventors were provided a subcontract under Purchase Order 4200787931. The U.S. government may have certain rights in the invention.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to data communication networking and more particularly to systems and methods for high-speed digital data communication over existing wiring in legacy platforms and infrastructure.

### SUMMARY

The present disclosure provides systems and methods for transmitting high speed digital network data over existing wiring. That is, according to some embodiments, communicating high-speed digital data over legacy wiring in air, land, and marine platforms, as well as infrastructure and the like. For example, the disclosed systems and methods are beneficial for legacy aircraft since they were designed, developed, and manufactured before modern high speed communications were standardized, so they typically lack the communications infrastructure required to integrate advanced systems at remote points on the aircraft (e.g., wing stations, aft equipment bays and the like). Retrofitting is a conventional option, but is impractical and cost prohibitive. The disclosed communications technology enables a high bandwidth network infrastructure (e.g., on an aircraft) to take advantage of the advancements in sensor and payload technology since the production of such aircraft.

According to some embodiments, the disclosed systems and methods can establish a robust, high bandwidth, point-to-point or multi-point Ethernet network over existing wiring. The disclosed instant communications technology can dramatically increase data throughput on installed, legacy wiring, cables, and power lines. For example, the disclosed systems and methods enable legacy aircraft to be upgraded with modern digital avionics that require the additional bandwidth, including cockpit controls and displays, imaging sensors, processors, software-waveform radios, synthetic vision and the like.

In accordance with one or more embodiments, a method is disclosed for high-speed digital data communication over legacy wiring. In accordance with one or more embodiments, a non-transitory computer-readable storage medium is provided, the computer-readable storage medium tangibly storing thereon, or having tangibly encoded thereon, computer readable instructions that when executed cause at least one processor to perform a method for high-speed digital data communication over existing wiring. In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a non-transitory computer-readable medium.

In general in one aspect, the invention features a communication system that includes a legacy vehicle including a system of existing wiring. The wiring connecting at least two locations on the legacy vehicle. The communication system further includes a transceiver installed at each location on the legacy vehicle. The transceiver integrated with the existing wiring at each location. The communication system further includes communication equipment connected with each transceiver at each location. The communication equipment at a first location is operable to communicate with the communication equipment at a second location over the existing wiring via each transceiver at the first location and the second location.

Implementations of the invention can include one or more of the following:

The legacy vehicle can be a legacy aircraft.

The communication system can include a thermal management system located at least one of the locations.

The thermal management system can be operable over an extended ambient temperature range, wherein the extended ambient temperature range is from −55° C. to +85° C.

The thermal management system can include a thermostat controller and at least one of a heating device and a cooling device.

The thermal management system can include a heating device selected from the group consisting of a heating circuit, a heating pad, and a combination thereof.

The communication system can include the thermal management systems at each of the locations.

The communication system can be operable to provide increased throughput communication over the existing wiring. The increased throughput can be more than 10 times the throughput of the existing wiring without the transceivers.

The increase throughput can be more than 1000 times the throughput of the existing wiring without the transceivers.

The communication system can be operable to provide digital communication over the existing lines of the legacy vehicle.

At least one of the transceivers can be operable to provide a direct link to a complementary transceiver located a position remote to the legacy vehicle.

The wiring can be connecting at least three locations on the legacy vehicle. The communication system can be a distributed system or a multiple-independent network system.

At least one of the transceivers can be contained in a sealed enclosure.

The sealed enclosure can protect the transceiver from environmental conditions.

The environmental conditions can include moisture, condensation, sand, dust, high vibrations, and high shock.

The transceiver in the sealed enclosure can include a printed circuit board, a jumper circuit, and a thermal circuit. The sealed enclosure can have a connector to connect the transceiver contained within to the existing wiring.

The transceiver at each location can include a printed circuit board, a jumper circuit, and a thermal circuit. The communication system can further include a connector to connect the transceiver at the location to the existing wiring.

In general in another aspect, the invention features a method that includes a process, implemented by a computing device comprising a processor, to enable high-speed data communication over existing wiring on a legacy vehicle.

Implementations of the invention can include one or more of the following:

The legacy vehicle can be a legacy aircraft.

The process can include utilizing a communication system installed on the legacy vehicle. The communication system can include the existing wiring. The wiring can connect at least two locations on the legacy vehicle. The communication system can further includes a transceiver installed at each location on the legacy vehicle. The transceiver can be integrated with the existing wiring at each location. The communication system can further include communication equipment connected with each transceiver at each location. The communication equipment at a first location can be communicating with the communication equipment at a second location over the existing wiring via each transceiver at the first location and the second location.

The method can further include utilizing a thermal management system over an extended ambient temperature range.

The step of utilizing a thermal management system can include detecting that the temperate at the transceiver locate at one the locations is outside a predetermined range of temperatures for operation of the transceiver at the location. The step of utilizing a thermal management system can further include halting power to the transceiver at the location. The step of utilizing a thermal management system can further include using the thermal management system to heat or cool temperature around the transceiver at the location such that the transceiver is within the predetermined range. The step of utilizing a thermal management system can further include reinstating power to the transceiver.

At least one of the transceivers can be operable to provide a direct link to a complementary transceiver located a position remote to the legacy vehicle.

The wiring can be connecting at least three locations on the legacy vehicle. The communication system can be a distributed system or a multiple-independent network system.

The transceiver can be contained in a sealed enclosure.

The sealed enclosure can protect the transceiver from environmental conditions.

The environmental conditions can include moisture, condensation, sand, dust, high vibrations, and high shock.

The transceiver in the sealed enclosure can include a printed circuit board, a jumper circuit, and a thermal circuit. The sealed enclosure can have a connector to connect the transceiver contained within to the existing wiring.

The extended ambient temperature range can be from −55° C. to +85° C.

The transceiver at each location can include a printed circuit board, a jumper circuit, and a thermal circuit. The communication system can further include a connector to connect the transceiver at the location to the existing wiring.

The high-speed data communication can provide increased throughput communication over the existing wiring, and wherein the increased throughput is more than 10 times the throughput of the existing wiring without the process.

The increase throughput can be more than 1000 times the throughput of the existing wiring without the transceivers.

The high-speed data communication can include digital communication over the existing lines of the legacy vehicle.

In general in another aspect, the invention features a non-statutory computer-readable storage medium tangibly encoded with computer-executable instructions, that when executed by a processor associated with a computing device, perform a method for high-speed data communication over existing wiring on a legacy platform.

In general in another aspect, the invention features a system that includes a processor. The system further includes a non-transitory computer-readable storage medium for tangibly storing thereon program logic for execution by the processor. The program logic includes communication logic for transferring digital data over existing wiring on a legacy platform.

In general in another aspect, the invention features a transceiver device that includes a sealed enclosure. The transceiver device further includes a printed circuit board. The transceiver device further includes a jumper circuit. The transceiver device further includes a thermal circuit. The transceiver device further includes a connector for connecting to existing wiring to enable digital data communication throughout a vehicle.

In general in another aspect, the invention features a method that includes installing a first transceiver at a first location on a legacy aircraft. The legacy aircraft includes an infrastructure not capable of facilitating broadband communication within locations of the aircraft. The installing includes integrating the first transceiver with existing wiring at the first location. The method further includes installing a first broadband device at the first location. The first broadband device connected to the first transceiver. The method further includes installing a second transceiver at a second location on a legacy aircraft. The installing includes integrating the second transceiver with existing wiring at the second location. The method further includes installing a second broadband device at the second location. The second broadband device connected to the second transceiver. The first and second broadband devices are capable of communicating broadband data over existing wiring via the first and second transceivers.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating components of a transceiver device in accordance with embodiments of the present disclosure;

FIG. 2 is a system diagram illustrating a communication system in accordance with embodiments of the present disclosure;

FIG. 3 is a system diagram illustrating a communication system in accordance with embodiments of the present disclosure;

FIG. 4 is a system diagram illustrating a communication system in accordance with embodiments of the present disclosure; and

FIG. 5 is a block diagram illustrating architecture of a hardware device in accordance with one or more embodiments of the present disclosure.

### DETAILED DESCRIPTION

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

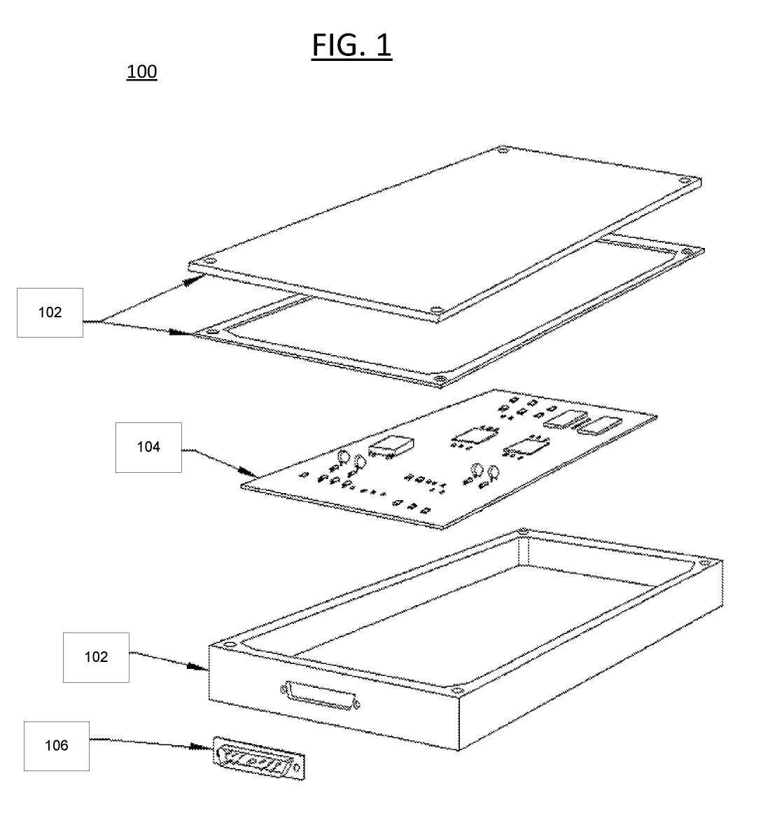

For the purposes of this disclosure the term “transceiver” should be understood to refer to a service point which provides processing, database, and communication facilities. By way of example, and not limitation, the transceiver can refer to a single, physical processor with associated communications and data storage and database facilities, or it can refer to a networked or clustered complex of processors and associated network and storage devices, as well as operating software and one or more database systems and application software that support the services provided by the server. Transceivers may vary widely in configuration or capabilities, but generally a transceiver may include one or more central processing units (and memory) as illustrated and discussed in more detail below with relation to FIG. 1. A transceiver may also include one or more mass storage devices, one or more power supplies, one or more wired or wireless network interfaces, one or more input/output interfaces, or one or more operating systems.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1 or T3 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, Bluetooth Low Energy Technology (BLE) as a function of the Bluetooth Core Specification Version 4.0 of Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, a computing device may be operative as a transceiver as discussed herein. Such devices may vary widely in configuration or capabilities, but generally a device/transceiver may include one or more central processing units as discussed above and understood by those of skill in the art. Thus, the device or transceiver discussed herein is capable of sending or receiving signals, such as via a wired or a wireless network. Such devices may, for example, include a radio frequency (RF) device, an infrared (IR) device, a Near Field Communication (NFC) device, a personal computer, a handheld computer, a tablet computer, a laptop computer, a set top box, a wearable computer, an integrated device combining various features, such as features of the forgoing devices, or the like.

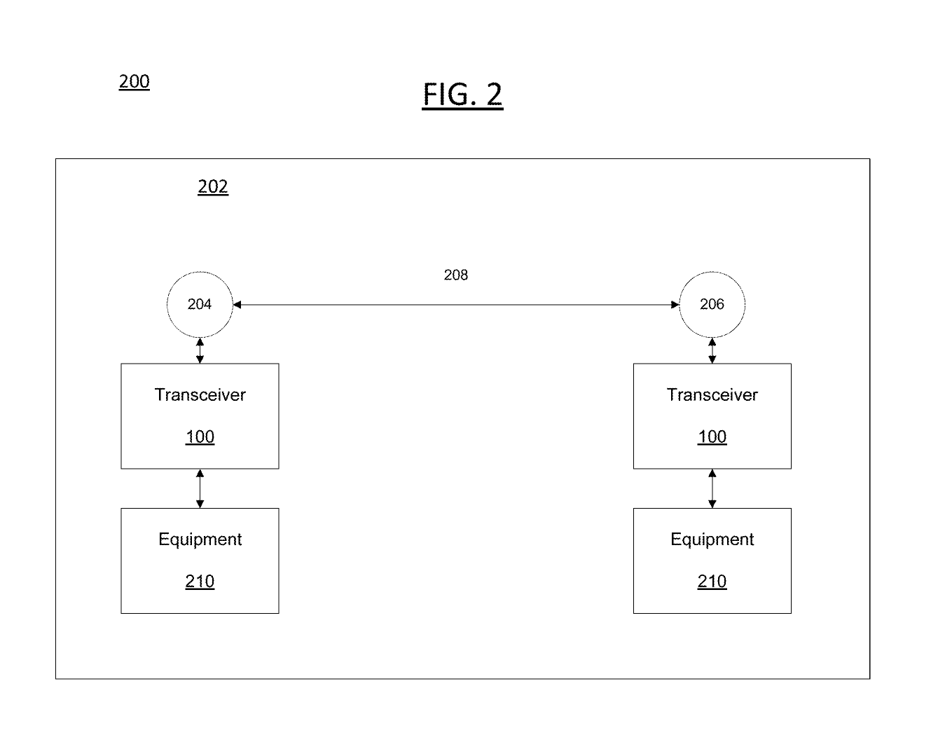

A device or transceiver may vary in terms of capabilities or features. The disclosed and claimed subject matter are intended to cover a wide range of potential variations. A device or transceiver may include or may execute a variety of computer and mobile operating systems. A device or transceiver may include or may execute a variety of possible applications, such as a client software application enabling communication with other devices, as discussed below with reference to FIGS. 2-4. The foregoing is provided to illustrate that claimed subject matter is intended to include a wide range of possible features or capabilities.

The principles described herein may be embodied in many different forms. The present disclosure provides systems and methods for transmitting high speed digital network data over existing wiring in legacy platforms and infrastructure. According to some embodiments, the disclosed systems and methods are implemented for communicating high-speed digital data over legacy wiring and infrastructure in air, land, and marine platforms, and the like. For example, the disclosed systems and methods are beneficial for legacy aircraft since they were designed, developed, and manufactured before modern high speed communications were standardized, so they typically lack the communications infrastructure required to integrate advanced systems at remote points on the aircraft (e.g., wing stations, aft equipment bays and the like).

Retrofitting legacy vehicles (e.g., aircraft or other marine, land or air vehicles) with fiber optics or adding additional signal transmission channel elements (e.g., copper wires or cables) is not an option due to cost, depot time and considerations of space, weight and power. Thus, the disclosed systems and methods address such shortcomings associated with retrofitting a legacy platform by enabling a cost-effective and efficient installation of a digital data communication network on existing wiring, thus enabling the legacy platform to take advantage of the advancements in sensor and payload technology since the production of such aircraft. In some embodiments, for example, the disclosed systems and methods can provide aggregate data rates that can approach 1 Gb/s.

According to some embodiments, the disclosed systems and methods can establish a robust, high bandwidth, point-to-point or multi-point Ethernet network over existing wiring. The disclosed communications technology can dramatically increase aircraft data throughput on installed, legacy wiring, cables, and power lines. By way of non-limiting example, such increases in throughput can effectuate an increase from 10x to 1000x. This enables, for example, legacy aircraft to be upgraded with modern digital avionics that require the additional bandwidth, including cockpit controls and data links, displays, imaging sensors, processors, software-waveform radios, synthetic vision and the like.

According to some embodiments of the present disclosure, the disclosed communication technology achieves the above solutions by integrating state-of-the-art power line communication (PLC) technology (which provides digital communications over power lines) into devices specifically designed for harsh electrical and physical environments.

It should be understood that while the instant disclosure discusses the implementations of the disclosed systems and methods with respect to aircraft, it should not be construed as so limiting, as the disclosed systems and methods can be applied to any known or to be known device, land, air or marine system, such as, for example, a vehicle, boat, train, home, apartment, housing complex, aircraft, and the like, without departing from the scope of the instant disclosure. Indeed, the disclosed systems and methods can be implemented on many known or to be known defense aircraft, battle tanks, warships, and shipboard platforms, and the like.

In some embodiments, locations on the aircraft platform have an associated transceiver providing a direct link to a complementary transceiver at a remote location. In some embodiments, several transceivers can form a mesh Ethernet network linking multiple components together throughout a platform. In some embodiments, the transceivers can establish multiple independent links between equipment by utilizing different platform wiring channels or implementing multiplexed channels over the same wiring.

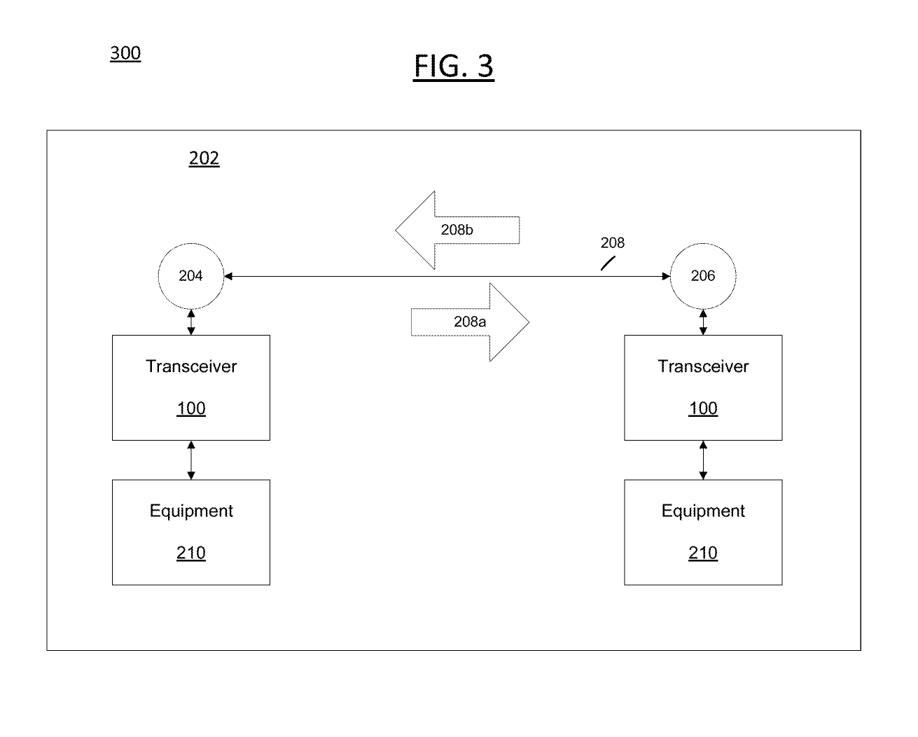

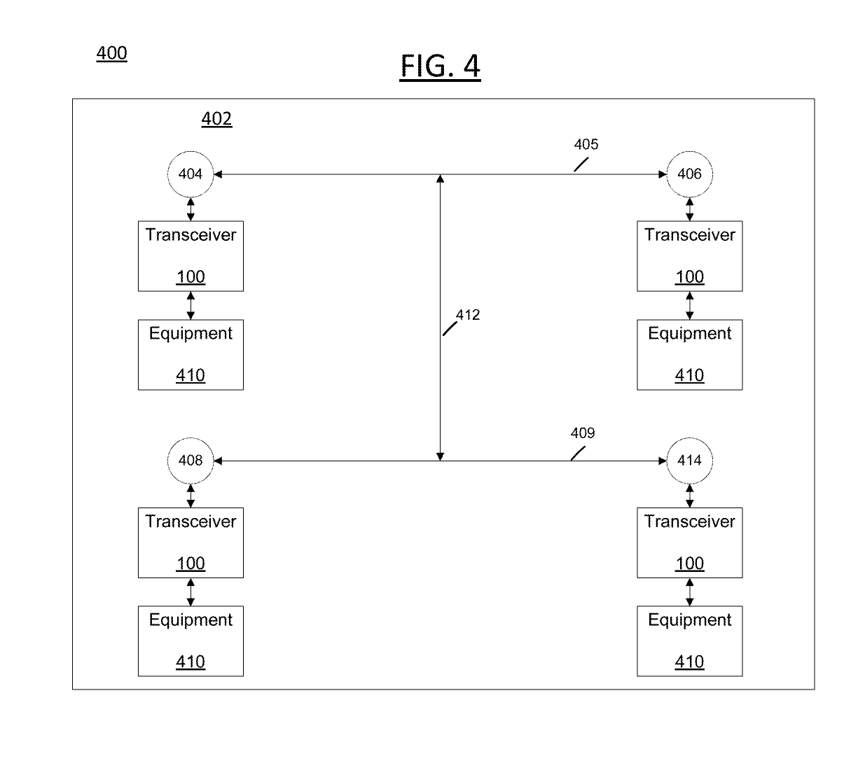

According to some embodiments, as discussed in more detail below, embodiments for implementing the disclosed systems and methods are depicted in FIGS. 2-4: Point-to-point system 200 as illustrated in FIG. 2; Distributed systems (referred to as “multi-point”) 300 as illustrated in FIG. 3; and Multiple independent networks (or PLC networks) system 400 as illustrated in FIG. 4. While the present disclosure discusses PLC technology, it should be understood that any known or to be known PLC unit, or variation of PLC technology can be utilized for implementing the disclosed systems and methods discussed herein.

Turning to FIG. 1, according to some embodiments, each embodiment discussed in FIGS. 2-4, as discussed below, includes a transceiver device 100 that can be spliced into existing wiring and/or cabling to receive and transmit signals across such wiring, thereby resulting in a transparent and uninterrupted high-speed data communication system. Such device 100 is enclosed with a sealed enclosure 102 to protect the electronics of the device 100 from the physical environment, a printed circuit board (PCB) 104 and a sealed connector 106 to interface with existing aircraft wiring.

In some embodiments the sealed enclosure 102 is configured as a ruggedized enclosure, and in some embodiments may be coated with a ruggedized sealant or coating to protect the internal components. In some embodiments, the coating helps prevent corrosion from, for example, water, saltwater, hydraulic fluid, fuel and other corrosive substances and chemicals. The enclosure 102 is sealed to prevent moisture, sand, and dust incursion, and the like, as well as handling drastic changes in environmental conditions (e.g., pressure, temperature, and the like). The enclosure 102 is also RF sealed to minimize unwanted emissions and protect the internal components from high power external radiated frequencies (that are typically associated with an aircraft, for example). The enclosure 102 can be metal, aluminum, or some other similar material that minimizes weight and controls emissions while maintaining stability and effectiveness of the transceiver device 100.

The enclosure 102 guards against vibrations and shocks (e.g., on planes, helicopters), environmental conditions (e.g., over-heating, rain, sprays), and can handle high altitudes, and the like. The enclosure 102 guards against, among other factors, condensation, which prevents shorting out. The enclosure 102 also includes mounting capabilities and features that enable secure interface to existing wiring to withstand high vibration and shock environments, including, for example, “crash safety” (i.e. it does not break loose and become a projectile in the event of a crash). Additionally, the enclosure 102 also has internal mounting for the internal components (e.g., PCB 104 and connectors) so that such components may withstand similar high vibration and shock environments. According to some embodiments, the transceiver device 100 may not be configured with external LEDs, which ensures that the transceiver device 100 is environmentally and electromagnetically sealed.

According to some embodiments, the transceiver device 100 can incorporate an Ethernet switch (e.g., Gigabit Ethernet switch—GbE) and multiple PLC channels, which can increase the aggregate bandwidth when multiple wiring and/or wiring networks are present on an aircraft.

As discussed above, the transceiver device 100 interfaces directly with existing wiring and provides for the acceptance of high-speed digital data (e.g., broadband or Ethernet) communication from network equipment. As discussed herein, the PCB 104 of the transceiver device 100 is configured to convert digital Ethernet data into modulated RF signals. The PCB 104 also contains an appropriate power supply and coupling, filtering, and protection circuitry to interface to the existing wiring. The power supply associated with the PCB 104 can convert external power into filtered power for the electronic chips associated with the PCB 104. The coupling/filtering/protection circuitry of the PCB 104 provides the physical interface to the existing (aircraft) wiring through the sealed connector 106, which also protects the PCB 104. According to embodiments of the present disclosure, the PCB 104 is configured as a semi-rigid, flexible and folded over on itself to minimize the enclosure 102 footprint. The PCB 104 is conformal coated to prevent corrosion from, for example, water, saltwater, hydraulic fluid, fuel and other corrosive substances and chemicals.

In accordance with embodiments of the present disclosure, the PCB 104 is fitted with circuitry including, but not limited to, robust input and output protection and filtering to meet communication and/or military standards (such as, but not limited to, MIL-STD-461F, MIL-STD-704A, and the like). The PCB 104 can communicate PLC signals separately to enable connection to various wiring mediums associated with legacy aircraft and other platforms. The PCB 104 can be configured with a zero-cross detection circuit bypassed to allow communication on differing types of wiring, such as, for example, wiring other than 50 Hz/60 Hz AC power lines.

According to some embodiments, the PCB 104 may be configured with a thermostat controller, heater circuit, and/or heating pad to enable operation at extreme low temperatures (where, for example, such temperatures may be associated with a pressure from a specific altitude).

In some embodiments, the PCB 104 can be configured with a custom, wide input power supply designed for automotive and aircraft DC power systems. Indeed, the PCB 104 can have a programmable output configuration to enable connection to different mediums, whereby the mediums may be associated with a legacy platform of a single aircraft, or between an aircraft and a station, or between aircraft, or some combination thereof. Indeed, such mediums may be dependent on the type of wiring, or connection network being utilized on an aircraft.

According to some embodiments, the transceiver device 100 can utilize differential (e.g., traditional) or common mode (CM) MIL-STD-1553 bus communication via the PCB 104. This CM mode eliminates interference with existing data bus traffic and provides increased signal propagation through stub couplers. In some embodiments, the transceiver device 100's PCB 104 can be tuned (automatically or according to predetermined settings, or user settings) to minimize or eliminate interference with existing systems by disabling offending frequencies.

According to some embodiments, the transceiver device 100 can utilize a jumper circuit as the sealed connector 106 to enable the use of any type of legacy wiring. The jumper circuit, as connector 106 or in connection with connector 106, is connected with PCB 104 and enables the transceiver 100 to connect to devices having any type of wiring, whereby a defined location (such as the fuselage) of the aircraft can be set as the ground. Conventional systems require the use of the same wiring and require all signals to be returned to the originating location; however, the jumper circuit implemented by the transceiver eliminates this as a separate defined location (e.g., fuselage) is set as the dedicated ground. Such supplementary ground wiring enables a shielding configuration(s) for the transceiver device 100, legacy wiring of the aircraft, and some combination thereof.

In accordance with embodiments of the present disclosure, the transceiver device 100 can utilize any commercially available technology that converts industry standard data packets (e.g., Ethernet) into a multitude of RF signals and superimposes these signals onto the existing wiring (transmission medium/network) of the aircraft. The device 100 can also receive the corresponding RF signals from a complementary (or remote) transceiver and convert them back into standard Ethernet packets. Such embodiments enable operation in typically challenging environments (e.g., extreme hot, cold, moisture, vibrations, altitude, and the like), as well as operation from voltages and frequencies with which are commercial standards specific (e.g., 115/230Vac, 50/60 Hz power systems, for example). As discussed herein, the transceiver device 100 enables the operation across and from additional voltages and frequencies, and communicates across many types of wiring and cabling.

According to some embodiments, the transceiver device 100 can be equipped with a thermal management system (or unit or circuit) associated with the PCB 104 which enables operation of the below systems discussed in FIGS. 2-4 over an extended temperature range, such as, for example, −55° C. to +85° C. The thermal system controls power to each system 200-400, transceiver device 100 or equipment 210, 410, or some combination thereof, whereby if the temperature is above or below a specified temperature range, the system 200-400 will not be allowed to function (e.g., denies power when outside of defined temperature range). Thus, the thermal system ensures that systems 200-400 maintain the desired temperature range by heating or cooling the device when it is above or below the predetermined temperature range (or threshold). By way of non-limiting example, an aircraft is flying over a region at a specific altitude, and when it is determined that the temperature (outside, inside or both) is outside the predetermined range, the communication system halts power (or powers down) to transceivers; however, in some embodiments, power will be reinstated to the transceivers when the thermal system is able to heat or cool the transceiver device 100 back to within the temperature range. In some embodiments, the thermal control system can monitor the temperature to ensure that the temperature range does not exceed the bounds of the range—by heating or cooling when temperatures drop or rise, respectively.

It should be understood that the enclosures, components and connector(s) discussed herein in connection with the transceiver device 100 are non-exhaustive, as additional or fewer components, sub-components or combinations of components may be applicable to the embodiments of the systems and methods discussed herein. The operations, configurations, and functionalities of the transceiver device 100 and each component discussed above, and their role within embodiments of the present disclosure will be discussed in more detail below.

Turning to FIG. 2, a point-to-point system 200 is disclosed which involves a transceiver device 100 installed at distinct connected locations. System 200 shows two locations 204 and 206 on an aircraft 202. As discussed above, the disclosure is not limited to an aircraft, as the disclosed systems and methods associated with system 200 can be applied to any known or to be known device, system, vehicle, boat, ship, tank, train, home, apartment, housing complex, and the like. Additionally, FIG. 2 is discussed with respect to two locations on an aircraft 202; however, it should be understood that the number of points can vary depending on the desired connectivity over legacy wiring on the aircraft—for example, there can be three points, a location associated with the cockpit, and one point for each wing.

A transceiver device 100 is installed at locations 204, 206. Communication equipment 210 is connected to each transceiver. Equipment 210 is a device for communicating high-speed data between locations 204 and 206. The equipment 210 can be, for example, broadband communication equipment.

By way of non-limiting example, as discussed above, location 204 can be associated with the cockpit and location 206 can be associated with the tail of the aircraft. Thus, one transceiver device 100 can be installed in direct association with the cockpit instrumentality 204, and another transceiver device 100 installed at a position on the tail 206 of the aircraft. Each transceiver device 100 can interface with instrumentality at such locations thereby enabling high-speed communication (e.g., broadband connectivity) over existing wiring 208 between the equipment 210 at each location on the aircraft. As discussed above, legacy wiring not fit for broadband communication could not enable high-speed digital communication between these two points; however, each transceiver device 100 enables modern communication equipment 210 (e.g., broadband or Ethernet) to execute and communicate with each other. That is, the broadband equipment 210 interfaces with the transceiver device 100 at location 204, which in turn analyzes the signal, parses and modifies it for communication over the legacy wiring 208 to the other fixated location 206 fit with the other transceiver device 100. The receiving transceiver device 100 associated with equipment 210 can receive the data from the transmitting transceiver and provide the data to its local equipment 210 for processing.

Turning to FIG. 3, the distributed or multi-point system 300 is disclosed which involves a transceiver device 100 being installed at each location 204, 206. Each transceiver device 100 is associated with broadband equipment 210, in a similar manner as discussed above in FIG. 2. The transceiver devices 100 interface the broadband equipment 210 to existing wiring 208 in the legacy platform existing on the aircraft. The broadband equipment 210 communicates directly to the transceiver devices 100 which, in turn, forward the data over the existing platform wiring to all remote transceivers. The transceiver devices 100 receive the data from a remote transceiver over the existing wiring and, if intended for the local equipment, the data is provided to the local equipment. Each transceiver device 100 repeats the received data on the platform wiring to ensure the communications signals reach all attached transceivers. That is, the communication occurring over wiring 208 is repeated in that a communicated signal from location 204 sent over wiring 208 (signal 208a) is then communicated back (or to another transceiver is applicable on the aircraft) over wiring 208 (signal 208b). This ensures that signals are effectively communicated to provide reliable and accurate signals and responses, as such communication, for example on an aircraft, need be accurate and timely in order to ensure the safety and directive associated with the communications.

Turning to FIG. 4, the multiple independent network system 400 involves a transceiver device 100 being installed at each location where communication (or, for example, broadband) equipment 410 is to be installed, as discussed in above in FIGS. 2-3. As illustrated in FIG. 4, there are 4 locations: 404, 406, 408, 414 associated with aircraft 402. For example, the locations can respectively be associated with the cockpit, left side wing, right side wing and the tail. Each transceiver device 100 interfaces the communication equipment 410 (e.g., broadband equipment) at each location to existing wiring in the aircraft 402. As illustrated, the transceiver device 100 at location 404 interfaces equipment 410 to legacy wiring 405, which is connected to location 406. The transceiver device 100 at location 406 is integrated in a similar fashion. Additionally, the same integration occurs between locations 408 and 414 over wiring 409. In some embodiments, an independent network of transceivers (and locations) can be established, where each independent network of transceivers can be connected to unique platform wiring between each location where they provide full available bandwidth for the equipment in that network. Example of such platform wiring for an aircraft can include, but is not limited to, AC or DC power busses, MIL-STD-1553 data bus channel A or B, discrete wiring, and the like. In some embodiments, each independent network of transceivers may be connected to the same platform wiring where they share the available bandwidth for the equipment in each respective network. Additionally, each network of transceivers (e.g., grouped, clustered or interconnected—e.g., wing transceivers) can communicate with other networked transceivers, whereby an effectuated network to network transceiver connection can be established over wiring 412 (e.g., locations 404 and 406, as a network; and locations 408 and 414, as another network, communicating with each other over wiring 412). For example, a grouping of transceivers associated with both wings can form a network of transceivers (e.g., as one transceiver unit) for communication with the cockpit.

According to some embodiments, each system discussed above (e.g., point-to-point system 200, multi-point system 300 and multiple independent network system 400) can establish PLC channel(s) for communication over existing platform wiring. That is, communications between each transceiver occurs over established PLC channels which can be implemented over legacy wiring, for example, but not limited to, aircraft AC/DC power wiring, control wiring, MIL-STD-1553 data bus wiring, and the like. According to embodiments of the present disclosure, each embodiment's implementation is viable on shielded or unshielded twisted pairs, or even single wires with a conductive chassis/fuselage as a return path, whether the wiring is energized or not. According to embodiments of the present disclosure, each embodiment's implementation is also compatible with MIL-STD-1553 data bus wiring and may be directly connected to the bus or connected through a stub coupler, and it functions independent of the existing data on the bus. Indeed, a PLC channel can be established as long as there is a conductive path between locations on the aircraft.

Thus, as discussed above, and in more detail below, the disclosed systems and methods enable the capability of intercommunications within an aircraft and/or between an aircraft and communicating station or device without the addition of new wiring or cable infrastructure through the implementation of the disclosed transceiver device that interfaces with an existing legacy platform thereby enabling high speed digital communication not previously supported.

In connection with the above discussion, each integrated transceiver device 100 is comprised within an individual enclosure (as discussed in FIG. 1), and can perform actions which effectuate the expansion of data transfer rates within legacy aircraft. As discussed above, the transceivers provide compatible interface to the existing platform wiring, including protection from potentially harmful conditions and compliance with all applicable standards (e.g., military standards). The transceivers also provide a ruggedized enclosure with appropriate physical and electrical sealing to allow operation in extreme environments, such as, but not limited to, high or rapidly changing altitudes and in high vibration/shock conditions.

According to some embodiments, the transceiver being implemented in systems 200-400 can encode and encrypt the Ethernet data being transmitted within aircraft 202 and 402. The communication occurring between transceivers within each system 200-400 can be enabled as a stand-alone network to employ any form of computer readable media for communicating information from one electronic device to another. For security of the information, such information may be secured by using a known or to be known negotiated encryption key or a pre-defined encryption key.

The transceivers in each system 200-400 enable the broadband/Ethernet equipment 210, 410 to packetize and distribute the data across multiple radio frequency (RF) carriers, which can be modulated and combined into complex waveforms. Each system 200-400, through the transceiver device 100, can adjust the signal amplitude, modulation technique and frequency, and superimpose the signal onto the wiring. The transceivers can detect and amplify compatible communication signals on the wiring (repeating the signals if necessary as in FIG. 4, for example). In some embodiments, the transceivers can demodulate, decode, and/or perform error correction, and decryption of communicated signals, as discussed above. When signals are received, the transceiver reassembles the transmitted Ethernet packet and provides it to the local equipment. According to some embodiments, each system's 200-400 communication channels are continuously monitored (or periodically according to a predetermined time period or threshold), whereby the modulation techniques and carrier frequencies utilized to mitigate continuous or intermittent noise present on the wiring can be dynamically adjusted for optimal signal communication over the legacy wiring.

By way of a non-limiting example, broadband equipment is installed at in the cockpit for communication with the tail of the aircraft. In order for the equipment to communicate over the aircraft's legacy wiring, the disclosed transceiver is installed at each location. Therefore, a transceiver is integrated into the cockpit's instrumentality (e.g., legacy wiring) and another transceiver is integrated into the tail's instrumentality. Broadband equipment is then integrated (or connected to) each transceiver. Therefore, when the broadband equipment at the cockpit sends a high-speed digital signal not previously capable of being sent over the aircraft's infrastructure, the transceiver at the cockpit configures (or modulates) the signal as a PLC communication signal for transmission over the legacy wiring. This PLC signal is then analyzed (e.g., demodulated) by the receiving transceiver at the tail, and communicated to the broadband tail equipment. The demodulation enables the receiving broadband equipment to receive the signal in its digital form as originally generated from the cockpit's broadband equipment. Thus, broadband communication between two locations on a legacy aircraft has been achieved.

In some embodiments, systems 200-400 can employ various protocols that are used for communication over a network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, or the like. Versions of the Internet Protocol (IP) may include IPv4 or IPv6.

In connection to the above discussion, the disclosed systems and methods provide Ethernet networking in very harsh environments, like those found in military aircraft and other vehicles. These operating environments present unique requirements that existing commercial units need not meet. According to some embodiments, the disclosed systems and methods operate from the power sources available in typical aircraft (for example, military aircraft), and communicate over aircraft power bus wiring, discrete wiring, or MIL-STD-1553 bus cables, and the like, as discussed above. The disclosed systems and methods are operational at extended temperatures and altitudes (pressures), can tolerate large shocks and vibrations, and the like. The device(s) (e.g., transceiver effectuating or facilitating the disclosed systems and methods discussed herein) is completely sealed to prevent damage and corrosion from fluids and humidity/condensation, can tolerate extreme electrical conditions including voltage spikes and even lightning strikes, can operate when exposed to extreme conducted and radiated power across a large spectrum, and can control their own radiated emissions to levels several times more stringent than required by typical regulatory standards (e.g., Federal Communications Commission (FCC) and CE, indicating compliance with European regulation).

Thus, the disclosed systems and methods provide a targeted solution for equipping aircraft (or other systems as discussed above) with capabilities for digital and/or increased data transfer, which was not available prior to implementation of the disclosed systems and methods. In some embodiments, the implementation of the disclosed systems and methods need not comply with or be interoperable with competitive products or conform to any released PLC standards (e.g., HomePlug AV, AV2, IEEE 1901, G.hn, and the like), as implementations of the instant disclosure, in some embodiments, exceeds beyond the commercial applications to military applications, as discussed above.

According to some embodiments, the transceiver and associated (broadband) equipment that are integrated with a location's legacy wiring may be configured as one device, where the transceiver can not only supply the integration to the legacy wiring, but also provide the advanced signals that are being communicated over the network, as discussed herein. As discussed above in FIGS. 2-4, the transceiver and equipment are separate connected devices; however, as stated herein, such devices can be integrated as one device without departing from the scope of the present disclosure.

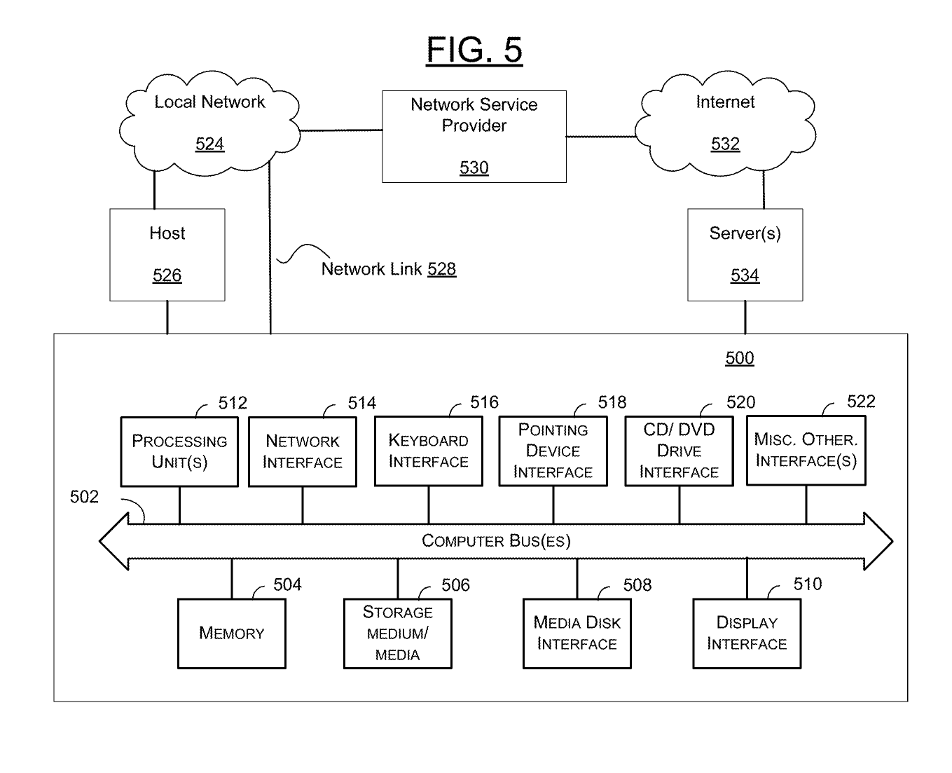

Turning to FIG. 5, internal architecture 500 of a transceiver and/or broadband equipment (e.g., components 100 and 210, 410 from FIGS. 2-4) can include one or more processing units, processors, or processing cores, (also referred to herein as CPUs) 512, which interface with at least one computer bus 502. Also interfacing with computer bus 502 are computer-readable medium, or media 506, network interface 514, memory 504 (e.g., random access memory (RAM), run-time transient memory, read only memory (ROM), and the like), media disk interface 508, media disk drive interface 520 as an interface for a drive that can read and/or write to media including removable media such as floppy, CD-ROM, DVD, media, display interface 510 as interface for a monitor or other display device, keyboard interface 516 as interface for a keyboard, pointing device interface 518 as an interface for a mouse or other pointing device, and miscellaneous other interfaces 522 not shown individually, such as parallel and serial port interfaces and a universal serial bus (USB) interface.

Memory 504 interfaces with computer bus 502 so as to provide information stored in memory 504 to CPU 512 during execution of software programs such as an operating system, application programs, device drivers, and software modules that comprise program code, and/or computer executable process steps, incorporating functionality described herein, e.g., one or more of process flows described herein. CPU 512 first loads computer executable process steps from storage, e.g., memory 504, computer readable storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

Persistent storage, e.g., medium/media 506, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 528 typically provides information communication using transmission media through one or more networks to other devices that use or process the information. For example, network link 528 may provide a connection through local network 524 (such as the legacy wiring) to a host computer 526 or to equipment operated by a Network Service Provider 530 (which may also be the legacy wiring). Such equipment can in turn provides data communication services through a public or private packet-switching communication network of networks, referred to as the Internet 532, in order for the aircraft to communicate with a base station or traffic tower, for example.

A computer called a server 534 connected to the Internet 532 hosts a process that provides a service in response to information received over the Internet 532. For example, server host 534 hosts a process that provides information representing video data for presentation at display 510. It is contemplated that the components of system 500 can be deployed in various configurations within other computer systems, e.g., host and server.

At least some embodiments of the present disclosure are related to the use of computer system 500 for implementing some or all of the techniques described herein. According to one embodiment, those techniques are performed by computer system 500 in response to processing unit 512 executing one or more sequences of one or more processor instructions contained in memory 504. Such instructions, also called computer instructions, software and program code, may be read into memory 504 from another computer-readable medium 506 such as storage device or network link. Execution of the sequences of instructions contained in memory 504 causes processing unit 512 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 500. Computer system 500 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processing unit 512 (e.g., a processor(s)) as it is received, or may be stored in memory 504 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described herein in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A communication system comprising:
(a) a legacy vehicle comprising a system of existing wiring, said wiring connecting at least two locations on said legacy vehicle;
(b) a transceiver installed at said each location on said a legacy vehicle, said transceiver integrated with said existing wiring at each location; and
(c) communication equipment connected with each transceiver at each location, said communication equipment at a first location operable to communicate with said communication equipment at a second location over said existing wiring via each transceiver at the first location and the second location.

2. The communication of claim 1, wherein the legacy vehicle is a legacy aircraft.

3. The communication system claim 1, wherein the communication system comprises a thermal management system located at least one of the locations.

4. The communication system of claim 3, wherein the thermal management system is operable over an extended ambient temperature range, wherein the extended ambient temperature range is from −55° C. to +85° C.

5. The communication system of claim 4, wherein the thermal management system comprises a thermostat controller and at least one of a heating device and a cooling device.

6. The communication system of claim 5, wherein the thermal management system comprises a heating device selected from the group consisting of a heating circuit, a heating pad, and a combination thereof.

7. The communication system of claim 3, wherein the communication system comprises the thermal management systems at each of the locations.

8. The communication system of claim 1, wherein the communication system is operable to provide increased throughput communication over the existing wiring, and wherein the increased throughput is more than 10 times the throughput of the existing wiring without the transceivers.

9. The communication system of claim 8, wherein the increase throughput is more than 1000 times the throughput of the existing wiring without the transceivers.

10. The communication system of claim 1, wherein the communication system is operable to provide digital communication over the existing lines of the legacy vehicle.

11. The communication system of claim 1, wherein at least one of the transceivers is operable to provide a direct link to a complementary transceiver located a position remote to the legacy vehicle.

12. The communication system of claim 1, wherein the wiring is connecting at least three locations on said legacy vehicle and wherein the communication system is selected from the group consisting of (a) a distributed system and (b) a multiple-independent network system.

13. The communication system of claim 1, wherein at least one of the transceivers is contained in a sealed enclosure.

14. The communication system of claim 13, wherein the sealed enclosure protects the transceiver from environmental conditions.

15. The communication system of claim 14, wherein the environmental conditions comprise moisture, condensation, sand, dust, high vibrations, and high shock.

16. The communication system of claim 14, wherein the transceiver in the sealed enclosure comprises a printed circuit board, a jumper circuit, and a thermal circuit, and wherein the sealed enclosure has a connector to connect the transceiver contained within to the existing wiring.

17. The communication system of claim 1, wherein the transceiver at each location comprises a printed circuit board, a jumper circuit, and a thermal circuit, and wherein the communication system further comprises a connector to connect the transceiver at the location to the existing wiring.

18. A method comprising a process, implemented by a computing device comprising a processor, to enable high-speed data communication over existing wiring on a legacy vehicle.

19. The method of claim 1, wherein said legacy vehicle is a legacy aircraft.

20. The method of claim 18, wherein the process comprises utilizing a communication system installed on the legacy vehicle, wherein the communication system comprises:
(a) the existing wiring, wherein said wiring connecting at least two locations on said legacy vehicle;
(b) a transceiver installed at said each location on said legacy vehicle, said transceiver integrated with said existing wiring at each location; and
(c) communication equipment connected with each transceiver at each location, said communication equipment at a first location communicating with said communication equipment at a second location over said existing wiring via each transceiver at the first location and the second location.

21. The method of claim 20 further comprising utilizing a thermal management system over an extended ambient temperature range.

22. The method of claim 21, wherein the step of utilizing a thermal management system comprises
(a) detecting that the temperate at the transceiver locate at one the locations is outside a predetermined range of temperatures for operation of the transceiver at the location,
(b) halting power to the transceiver at said location,
(c) using the thermal management system to heat or cool temperature around the transceiver at said location such that the transceiver is within the predetermined range, and
(d) reinstating power to the transceiver.

23. The method system of claim 20, wherein at least one of the transceivers is operable to provide a direct link to a complementary transceiver located a position remote to the legacy vehicle.

24. The method of claim 20, wherein the wiring is connecting at least three locations on said legacy vehicle and wherein the communication system is selected from the group consisting of (a) a distributed system and (b) a multiple-independent network system.

25. The method of claim 20, wherein the transceiver is contained in a sealed enclosure.

26. The method of claim 25, wherein the sealed enclosure protects the transceiver from environmental conditions.

27. The method of claim 26, wherein the environmental conditions comprise moisture, condensation, sand, dust, high vibrations, and high shock.

28. The method of claim 26, wherein the transceiver in the sealed enclosure comprises a printed circuit board, a jumper circuit, and a thermal circuit, and wherein the sealed enclosure has a connector to connect the transceiver contained within to the existing wiring.

29. The method of claim 20, wherein the extended ambient temperature range is from −55° C. to +85° C.

30. The method of claim 20, wherein the transceiver at each location comprises a printed circuit board, a jumper circuit, and a thermal circuit, and the communication system further comprises a connector to connect the transceiver at the location to the existing wiring.
